(19) United States
(12) Patent Application Publication
(10) Pub. No.: US 2014/0020360 A1
(43) Pub. Date: Jan. 23, 2014

(54) POWER GENERATION SYSTEM UTILIZING CIRCULATORY WATER FLOW IN TAPER CONDUIT

(71) Applicant: Ching-Shih Teng, New Taipei City (TW)

(72) Inventor: Ching-Shih Teng, New Taipei City (TW)

(21) Appl. No.: 13/824,937

(22) PCT Filed: Mar. 25, 2011
(86) PCT No.: PCT/CN11/00503

§ 371 Date: Oct. 7, 2013

(51) Int. Cl. F03B 17/02; F03B 1/00

(52) U.S. Cl. CPC F03B 17/02; F03B 1/00
USPC 60/221; 415/80

(57) ABSTRACT

A power generator system utilizing the jet power of circulatory water flow in taper conduits is provided. The system comprises four jet components (10,20,30,40), a Pelton turbine generators and a pumping-up tail water circulation device. The jet components (10,20,30,40) comprises a taper conduits. The taper conduit is combined by a front big diameter conduit (12), a middle 30° taper conduit (5), and a rear small diameter nozzle (6). A horizontal high pressured pump (4) is provided in the front big diameter conduit (12), and supplies enough power to the water flow in the conduit when it runs. The taper conduit (5) can increase the velocity of water flow to form high speed jet flow of the rear small diameter nozzle (6). The group of Pelton turbine generators is driven to generate electricity by utilizing the jet flow. The pumping-up tail water circulation device pumps the tail water from the sealed tail water pond to the ground, to circularly supply the water needed by the taper conduit.

### BACKGROUND OF THE INVENTION

1. Field of the invention

The present invention relates to hydraulic power generation system, and in particular, to a power generator system utilizing the jet power of circulatory water flow in taper conduits.

2. Description of the Prior Art

Presently the energy source of the whole world essentially depends on the large amount of petroleum to maintain human regular life. The economic and cultural growth of the whole world results in producing a large amount of CO₂ which brings about a severe problem of environmental contamination that leads to causing the world improper for all kinds of living creatures to maintain their health. Keeping pace with the progress of human civilization the necessity of energy is so eager that accelerates the gloval warmth to cause the world more improper for all the creatures and vigitation to survive.

Another problem is that when the final day of using up petroleum energy comes true, the whole world will get into a mess fighting one another for the energy source.

In view of the above situation, to solve the conflict between economic growth and environmental protection, it is a must to develop a new energy source, the clean energy. Seeking for green energy source is a paramount importance, every prominent country in the world has placed value on this idea and has been making all efforts trying to attain the aim so as to improve her statehood in the international community for recent years.

The solar energy, wind power, and hydraulic power are possible obtainable green energies at present. Among these the ample solar energy is easily obtainable without interference of another country so that it becomes a first choice for every country. But it is regretful that the installation for the solar energy requires a large solar cell panel because of its low efficiency resulting in inevitable expensive capital investment and broad installation area that is impossible for every country to try. The wind power, though it is bestowed upon a higher efficiency, yet it has to face the disadvantages of unstable wind flow and expensive installation cost. However it can play only a roll of auxiliary power source but not an essential one.

It is undoubtful the hydraulic power generation is the most economical green energy source. The commonest way of hydraulic power generation is gathering the river water by building a dam at a proper site in the river, so as to build up a water head and drive the water wheel thereby transforming the water energy to electric energy.

Meanwhile, it should be understood that not all the rivers are suitable for establishing water power plants. The country who has no sufficient water energy resource can't but seek help for other energy sources. There is a fatal disadvantage of hydraulic power generation that it requires a big capital investment, technique and time for installation in addition to tedious maintenance work and replacement of equipment in the following days. Besides, there is an innegligible problem that the damming of water flow may cause a certain damage to the environment so that a careful estimation before establishing a water power plants is very important, otherwise the advantage gained by development of water energy does not pay for its accompanying damages.

In view of the foregoing situation, the inventor of the present invention herein conducted intensive research based on many years of experience gained through professional engagement in this related technical field, with continuous experimentation and improvement finally came out with a power generator system utilizing jet power of circulatory water flow in taper conduits which can be applied anywhere without restriction of installation place.

### SUMMARY OF THE INVENTION

It is a main object of the present invention to provide a power generator system utilizing circulatory water flow in taper conduits in which a small number of pumps are used to incessantly pump up the tail water to form a circulatory water flow, and then intensify the speed of water flow in the taper conduits according to the principle of fluid mechanics so as to drive a Pelton wheel power generation system with the high speed jet flow thereby producing large scale commercially applicable electric power but spending only a small amount of water resources.

It is another object of the present invention to provide a power generator system utilizing jet power of circulatory water flow in taper conduits wherein the circulatory water flow can be incessantly self maintained for a long time so as to generate electricity thereby achieving the maximum effect. The installation site is optional without restriction.

To achieve the above objects, the power generator system of the present invention utilizes a minor pump power to incessantly and circularly pump up the tail water which falls down after driving Pelton turbine, up to above the ground into a water reservoir and horizontal taper conduits and nozzles. After exerting the pressure by the hp pump, the pressurized water flow in the taper conduits is converted into a high speed jet, according to the continuity equation of fluid mechanics so as to drive a Pelton turbine generating system thereby making it possible to produce large scale commercially applicable electric power. The power generator system of the present invention essentially comprises four jet components a Pelton turbine generator, and a pumping up tail water circulation device. The jet component further includes a hp pump, a taper conduit between a front big diameter conduit and a rear small diameter nozzle so as to convert the low speed water flow into a high speed jet flow in the rear small diameter nozzle according to the continuity equation of fluid mechanics. This high speed jet flow formed as such is effective for driving the Pelton turbine generator system to produce electric power. At the same time the pumping-up tail water circulation device pumps up the tail water from the sealed tail water pond wheel to the ground so as to incessantly supply water flow to the hp pump thereby realizing the idea of jet flow power generation through overcoming resistance of the taper conduits with the pump energy. With this small amount of pump power is able to produce commercial usable electricity.

### BRIEF DESCRIPTION OF THE DRAWINGS

FIG. 1 is a perspective view of the power generator system of the present invention.

FIG. 2 is an illustrative view showing the inner structure of the nozzle.

FIG. 3A is an illustrative view showing the structure of the tail water pump.

FIG. 3B is an illustrative view showing the structure of the high pressure pump.

FIG. 4 is an illustrative view showing the instrumentation on the pump main control switch board.

### LEGEND

10,20,30,40: jet component 50: water wheel 60: generator 70: inner structure of the jet component 1. tail water pump 2. overflow conduit 3: tail water path 4: pressure pump 5: 30° taper conduit 6: nozzle 7: temperature control chamber 8: mound 9: Pelton turbine 10: generator 11: sealed tail water pond 12: horizontal big diameter conduit 13: constant pressure water reservoir 14: machine room 31: tail water pump main switch 32: pressure pump main switch 33: instrumentation

### DETAILED DESCRIPTION OF THE PREFERRED EMBODIMENT

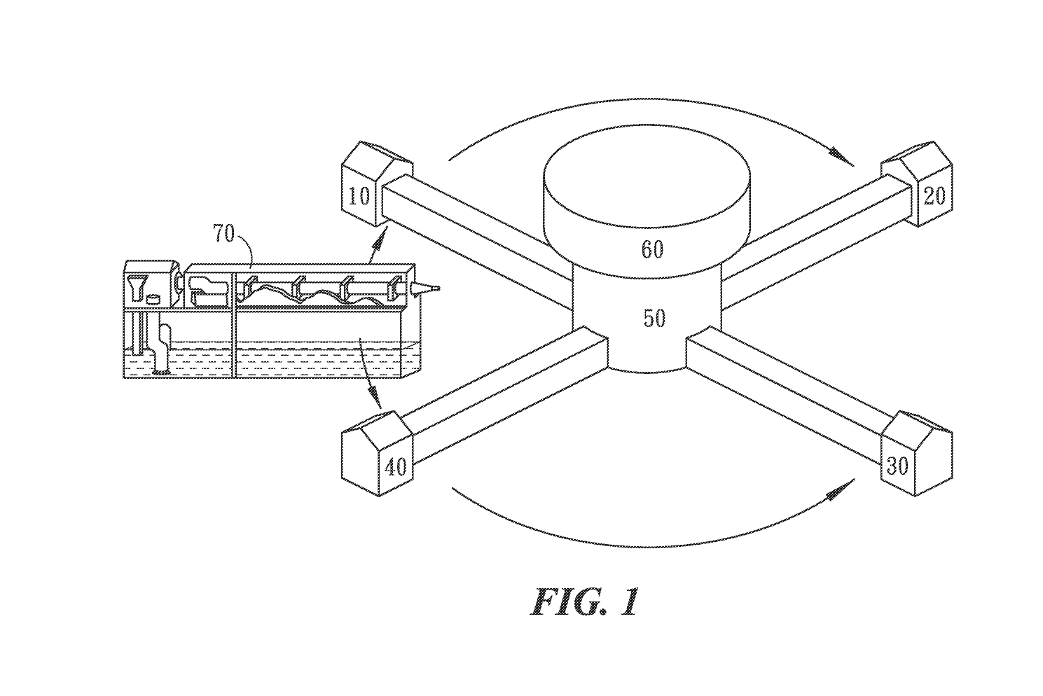

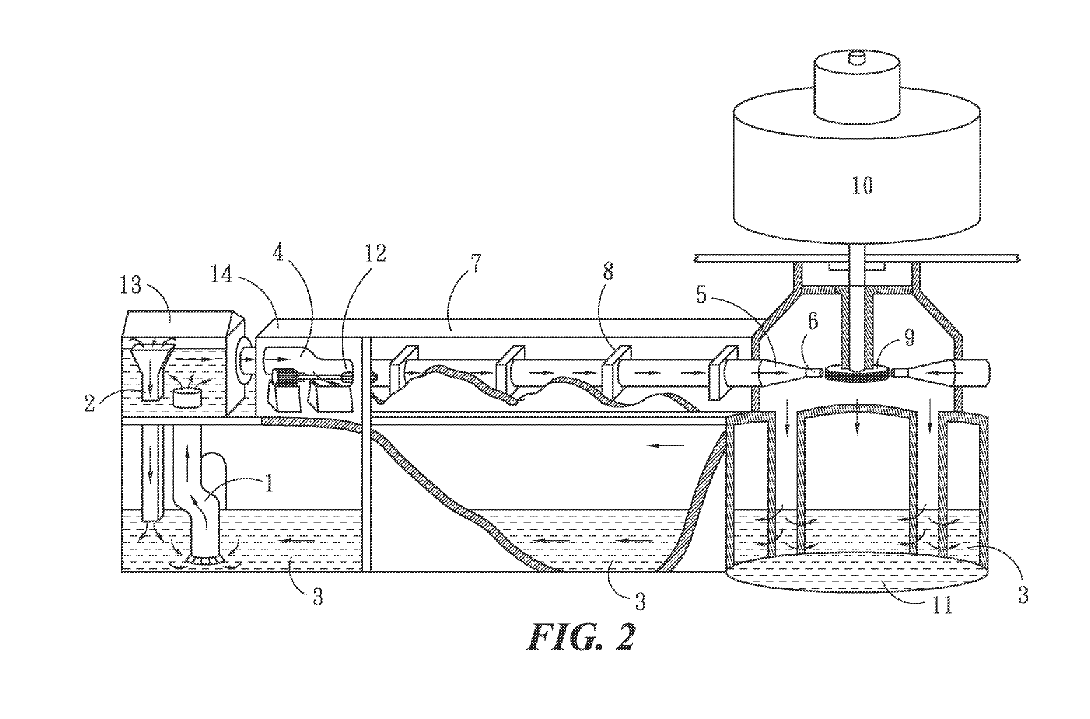

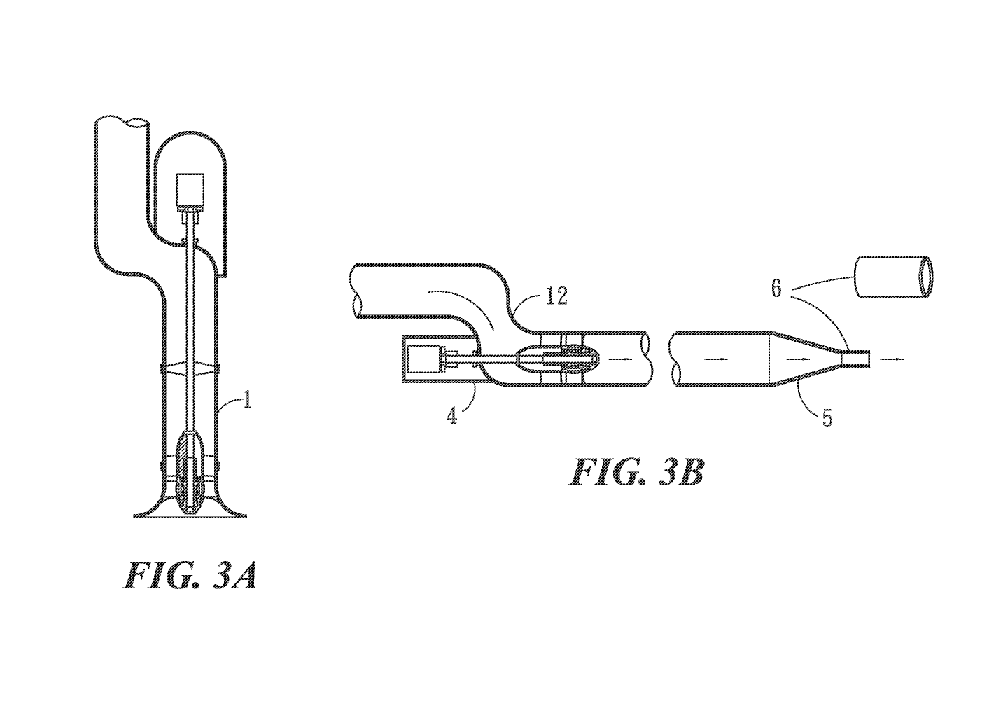

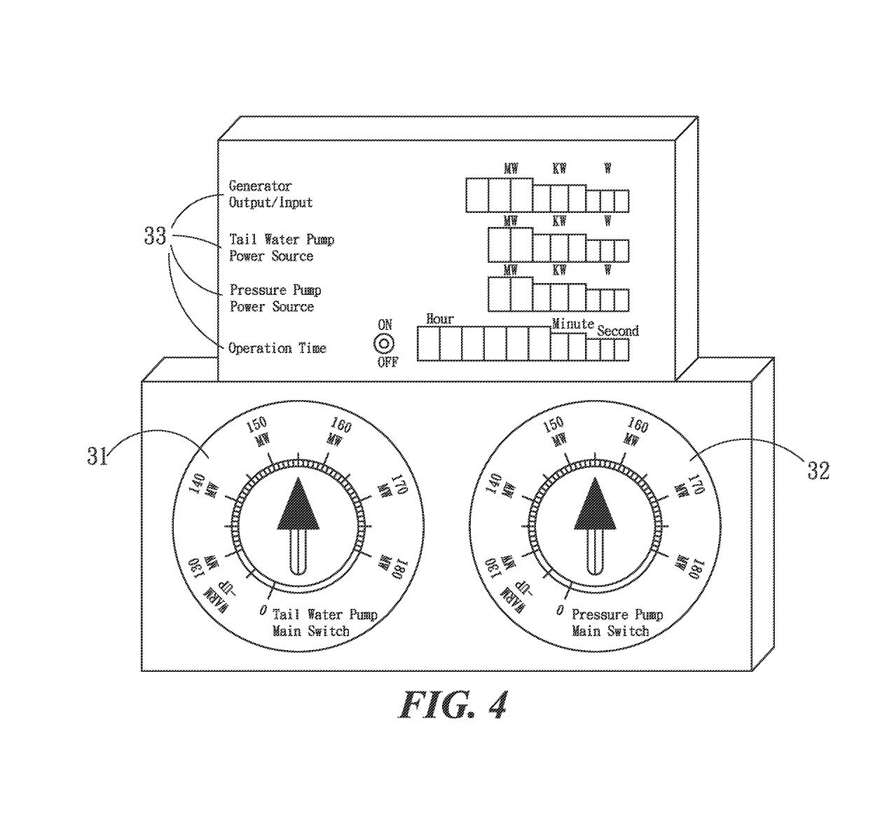

As shown in FIG. 1 through FIG. 4, the power generator system utilizing circulatory water flow in taper conduit (abridged as present system afterward) of the present invention comprises 1 to 6 nozzles and a Pelton generator unit. The nozzles of the present system will be defined as the jet components as its structure includes a tail water pumping device and three conduits a pressures pump.

For convenient to illustrate, there provides a specially designed generating equipment composed of a including four nozzles 10,20,30 and 40, an turbine chamberi 50, and a generator 60 with generation capacity of 130 MW˜180 MW. Each of the jet component 10,20,30,40 is in an elongated shape parting 90° one another and facing to the centrally situated generator 60 so as to form a large symbol of cross. The inner structure of the jet component 70 will be described later.

The structure of the power generator system utilizing the jet power of circulatory water flow in taper conduits

(1) For the convenience of illustrating power producing steps of the water flow speed and the water pump action, assuming herein the maximum generating capacity is 180MW as an example.

(2) The pumping-up tail water circulation device is composed of an underground tail water path 3, a tail water pump 1 with a water suction conduit, a constant pressure water reservoir 13, and a tail water main switch 31.

1. The underground tail water path 3 is 12 m long, 3 m wide, and 3 m deep elongated shape covered water pipe made of steel reinforced concrete. It is connected to the sealed tail water pond 11, and a 9 m long outermost conduit wall has a height of 3 m, above the ground so as to divide the space in two chambers. One of it accommodates the constant pressure water reservoir 13 of 3 m long and 3 m wide (same as that of the tail water path 3), another one is the machine room 14 for the high pressure jet flow device with the same constructural specification as that of the constant pressure water reservoir 13. Two rooms are 1 m apart and the underground tail water path 3 stores 2, 3 m deep water. When in operation, part of the water is pumped up above the ground leaving the 2.0 m deep residual water. This 2 m water level is unvaried because the same amount of tail water is pumped up and returns to the tail water path 3

2. The tail water pump 1 is a 1000 kw vertical axial flow pump for incessantly pumping up the tail water in the tail water path 3 to 6.46 m height (without counting 2 m water level of the underground tail water path, remaining 4 m is a lifted head), plus 2.46 m water height of the constant pressure water reservoir 13, the actual total lift will be 4 m+2.46 m=6.46 m. The tail water pump 1 is located in the underground tail water path 3 to pump up 6.8 m³/s water into the constant pressure water reservoir 13. The whole system consists of four nozzles 10,20,30 and 40, and four tail water pumps 1 controlled by the tail water pump main switch 31.

3. The 3 m long, 3 m wide and 3 m high constant pressure water reservoir 13 is made of steel reinforce concrete. In side of it essentially contains a feed water conduit (the top exit port of the vertical tail water conduit) and a funnel shaped overflow conduit 2 with its mouth upwardly directed. The reservoir 13 has a water head 2.46 m. Among 6.8 m³/s pumped up tail water, most part of its (6.33 m³/s) flows into the hp pump, rest of the tail water (0.47 m³/s) returns to the tail water path 3 via the overflow conduit 2 so that the water level of the reservoir 13 may constantly maintain the value 2.46 m, this is the reason why the reservoir 13 is named constant pressure reservoir. There is formed a 1 mΦ stainless steel conduit on the front wall of the reservoir 13 to transport the water to the jet component and jets the water out of the nozzle finally.

4. Four nozzles 10,20,30,40 together own for tail water pumps 1 controlled by the tail water main switch 31. On the rotary switch there are provided with graduated rings on which graduations indicating generated power. ON/OFF control of heat machines are marked. All the graduations are prepared by the instrumentation 33 according to the amount of power consumption of the two kinds of pumps displayed during product testing and commissioning period.

(3) The jet component of the present system is composed of the hp pump 4, a taper conduit constituted by horizontally connected thee conduits (horizontal big diameter conduit 12, 30° taper conduit 5, and nozzles), the pressure pump 4, four mounds 8, and the temperature control chamber 7.

1. Similar to the constant pressure water reservoir 13, the machine room 14 is built of steel reinforced concrete with the dimension 3 m high, 3 m long and 3 m wide, and stood at the place 1 m apart from the rear reservoir 13. The front end of the 1 mΦ horizontal big diameter conduit 12 is connected to the front wall of the reservoir 13 and then enters the machine room 14 and leaves from its front wall after making two 45° turns inside. The machine room 14 is mainly for accommodating a driving motor installed off the conduit for 12 MW lateral type axial flow pressure pump 4, the main shaft, the bearing box, and tools and spare parts prepared for the pump electrical wiring maintenance.

2. The taper conduits are the equipment for producing electric power with the high speed jet. It is composed of the horizontal big diameter conduit 12 (front section), the taper conduit 5 (middle section), and the nozzles 6 (rear section) connected together.

(1) The horizontal big diameter conduit 12 (front section) is 1 m in diameter and 12 m long. The top end of the steel pipe is connected to the reservoir 13 to draw out the water inside. This steel pipe is then enters the machine room 14 by penetrating its wall, and leaves the machine room 14 from its front wall after making two 45° turns inside, and then enters the turbine chamber 9 by extending a conduit of 12 m long. At the second 45° turn, the rotating vane of the axial flow high pressure pump 4 is installed inside the conduit. The main axis of the pump 4 is connected to the bearing box and to the motor located behind and outside of the curved conduit. The space 2 m in front of the 14 m extension conduit is used to hold the rotating vane of the pressure pump 4, remaining space in rear 12 m part is used as an “entrance zone” so as to form a “fully developed flow: (length of the entrance zone shall be 10 times as long as the diameter. In the present system the zone length is 12 m, that is 20% more). With this structure the middle section 30° taper conduit 5 may easily convert the low speed flow into high speed jet.

(2) Middle section 30° taper conduit 5 has a length of 1.5 m, front diameter 1 m, rear diameter 0.25 m. Its front end is connected to the terminal of the horizontal big diameter conduit 12, and its rear end is connected to the straight tube type nozzle 6. The ratio of front diameter to rear diameter (1 m:0.25 m) is 4:1, and the 30° taper conduit 5 has a frictional coefficient f=0.02 (according to Fluid Mechanics, by Prof. Cengal Cimbala U.S.A).

(3) Rear Section nozzle 6 is a straight nozzle with the length 0.75 m, diameter 0.25 m, the inside thereof is smooth without installing any valve mechanism.

3. Pressure Pump 4:

(1) This is a lateral type axial flow pump (motor capacity 1000 kw) installed in the second 45° turned conduit part of the big diameter conduit 12 (the motor and the bearing box are installed outside of the curved part, the rotating vane is in the conduit and connected with the main shaft). When in operation, the water in the conduit is exerted with a pressure so as to give the water flow sufficient energy to push it flow to the 30° taper tube with a velocity of 8.07 M/S able to overcome the taper conduit frictional resistance thereby converting the water flow into a high speed jet flow.

(2) Four nozzles 10,20,30,40 together own four pressure pumps 4 controlled by the pressure pump main switch 32. On the rotary switch there are provided with variously graduated rings on which graduations indicating generated power, ON/OFF control of heat machines are marked by the instrumentation 33.

4. The mounds 8 are placed in the big diameter conduit 12 of 12 m long laid between the machine room 14 and the water turbine chamber 9. The four mounds are made of steel reinforced concrete. The center line (point) of the conduit is above the ground 1.5 m.

5. The temperature control chamber 7 is located in the big diameter conduit 12 of 12 m long laid between the machine room 14 and the turbine chamber 9. The conduit is kept at normal ambient temperature by the temperature control chamber 7 built of an elongated heat isolation and anti-freezing material (warming machine for frigid zone).

(IV) Movable Small Generator

The power source of the pumps (tail water pump and pressure pump) in the present system is supplied essentially by the generated power of the system generator. However, at the beginning of starting present system, there is no stored power can be used. The required power must come from another source or any small scale generator unit to drive the pumps (required capacity is 10 MW for 8.2 MW total pump power requirement).

(V) Pelton Water Wheel Generator Unit 10:

This is a known generator unit used by the present system so it does not be needed to describe detailly in the technical scope of the present invention.

### II. Preferred Embodiment of the Present Invention

The steps of the present system operation are (1) warm up operation; (2) normal operation of power generation; (3) change over of the power generation; and stopping the operation.

(i) Warm Up Operation

1. Warming up is necessary before normal power generation. At first start the four tail water pumps and turn the co-used power source switch to start operating the heat machine. After running it for 20 min., start driving each tail water pump to run at a low speed so as to pump up small amount (about 50%˜60%) of tail water into and fill up the on-ground fixed water level reservoir. Time duration of 30 min. is required for the water to flow through the three taper conduits. After that turn the power source switch of the pressure pump to the mark “heat machine”, at this time the water flow is only able to jet out from the nozzles, but is not strong enough to drive the Pelton turbine.

2. Carry out an overall inspection in the 20 min. time duration at this stage, if everything is OK, then it is allowed to go into the step of normal power generation.

3. The necessary power in this stage may be taken from an outside source other than the power produced by the system generator, such as the storage power of other sources, or the power comes from any small generator.

(ii) Normal power generating operation (take 180 MW power generation as an example):

1. Starting the four tail water pumps of four nozzles in the nozzle group:

(1) Calculation of power required for pumping up the tail water and the amount of tail water:

A. Data:

(A) actual lift: underground 4 m+above ground 2.46=6.46 m;

(B) total head loss in conduits: 25%×6.46=1.62 m;

(C) pressure and flow speed on the suction side and the drainage side are equal;

(D) total lift H=6.46 m+1.62 m=8.1 m;

(E) amount of flow: nozzle side (6.33 m³/s)+overflow side (0.47 m³/s)=6.8 m³/s;

(F) specific gravity of water: assuming 1000 kg/m³ at 50° C.

(G) tail water pump efficiency: η=75%

B. Shaft power (KW) required for each pump can be estimated with equation

$$\begin{matrix}L = \frac{( r * m * H )}{102 \times η} \\ = \frac{( 1000 kg \text{/} m * 8.1 m * 6.8 {m}^{3} \text{/} s )}{102 \times 75 \%} \\ = 720 KW\end{matrix}$$

C. Shaft power required for total four tail water pumps in the system is 2880 kw.

(2) After starting the tail water pumps, the tail water is pumped up to fill the on-ground constant pressure water reservoir and connected taper conduits from the horizontal big diameter to the nozzles. The exit of the nozzles must have some water to flow out slowly. The height of the constant reservoir overflow hole is 2.46 m, the rate of water entering the reservoir is 6.8 m³/s which is then conducted into the taper conduits to form jet. The remaining 0.47 m³/s water flows back to the tail water path from the overflow conduit so as to maintain the reservoir's water height at a constant value of 2.46 m which is able to overcome the frictional resistance of the two 45° curved tubes of the big diameter conduit installed in the machine room. By so, the pressure formed of the constant pressure reservoir and its connected 0.96 m long big diameter conduit can be used to compensate the frictional resistance arises from the two 45° curved tubes to impose on the big diameter conduit (the part in the machine room) such that allowing to keep a no pressure state between the constant pressure water reservoir and the big diameter conduit. Evaluation of the related data is as follows:

DATA information:

(A) Frictional loss of two 45° curved tube is equivalent to that of a straight conduit with length L=2×16=32 m;

(B) Relative roughness of stainless steel pipe e/D=0.000007/3.281 ft=0.0000022;

(C) Stainless steel pipe coefficient of friction f=0.009;

(D) Flow speed; 8.07 m/s.

Substitute into the equation, frictional head loss of the two 45° curved tubes;

$$\begin{matrix}{h}_{L} = f * \frac{L}{D} * \frac{{V}^{2}}{2 g} \\ = 0.009 * \frac{32}{1} * \frac{{( 8.07 m \text{/} s )}^{2}}{2 g} \\ = 0.96 m\end{matrix}$$

Accordingly, 0.96 m head defference between higher reservoir and lower horizontal big diameter conduit (center line) can compensate the water head loss (0.96 m) of the two 45° curved tubes.

2. Starting the four pumps in the four nozzles:

(1) start the tail water pumps, at the same time start operation of the four pressure pumps in 4 jet component. Each pump exerts pressure on the tail water in the conduit with 12,043 KW so as to form a strong water flow, and perform two actions in the big diameter conduit:

\textcircled{1} First action: After flowing through a 12m long entrance zone a the velocity of 8.07 m/s, the flow has been converted to fully developed flow. To carry out this action, each high pressured pump requires a capacity of 415 KW.

DATA information:

(A) flow velocity (VI)=8.07 m/s;

(B) flow quantity (Q)=A×V=(π/4×D12)×8.07 m/s=6.33 m³/s;

(C) the weight of the water (m)=1,000 kg/m³ at 50° C.;

(D) pump efficiency=85%.

Substitute into equation

h_{L}major=f×L/D×V²/2 g=0.0174×10 m/1 m×(8.07 m/s)²/2 g=0.58 m

Wpumping L=m×g×h_{L}major×1/85%=6330 kw×5.7 m/s×1/85%=415 kw

Total power for four pumps=4×415 kw=1660 kw.

\textcircled{2} Second Action:

Flow entering 30° taper conduit, the water flow overcomes the frictional resistance of 30° taper conduit with 11,628 kw so as to allow the 30° taper conduit to convert the water flow into a high speed jet flow according to its diameter ratio 4:1 (big side 1 m, small side 0.25 m) and the equation of continuity, the required for the pressure pump to perform this action is calculated as follows:

DATA Information

(A) Velocity of water flow in the big diameter conduit (VI)=8.07 m/s;

(B) High speed jet flow to be converted by the 30° taper conduit (V2)=VI×(4D1/D1)²=8.07 m/s×16=129 m/s

(C) Coefficient of Friction of the 30° taper conduit (k)=0.02;

(D) The head loss caused by frictional resistance of the 30° taper conduit h_{L}=f×(V2)²/2 g=17 m

referring to the following equation;

WpumpingL=m×g×h_{L}minor×1/89%(hp pump efficient)=6330 kg×9.81 m/s²×(0.02×1651.3 m)×1/89%=11,628 kw;

Power required for all four pumps=4×11,628 kw=46,512 kw.

(2) After above two actions are performed by the four hp pumps, the flow is converted into a high speed jet flow of 129 m/s consuming the total power of 46,512 kw+1660 kw=48,172 kw.

3. Total power consumption of pumps to the power generated by the system;

power for four tail water pumps 2880 KW;

power for four pressure pumps 48,172 kw;

total power for the pumps: 2880 kw+48,172 kw=51,052 kw;

4. The high speed jet passing through the nozzle:

Basic datum and relative equations:

(1) The nozzle's diameter and cross section: D2=25 cm, A2=0.04908 m²;

(A2=D2/3.1416/4=D2/0.7854=0.04908 m²);

(2) Nozzle's Velocity:

(Q=A1×V1=A2×V2. So, V2=Q/A2=6.33 m³/0.04908 m²=129 m/s);

(3) Nozzle's efficiency: 97%;

(4) Nozzle's kinetic energy: 51,059 kw.

(KE=1/2×m×V2/g×97%=m×V2/2 g×97%=6,330 kg×(129 m/s)²/2 g×97%=51,059 kw)

5. Overall efficiency of the generator unit=88.2% (large water wheel efficiency 90%×large generator efficiency 98%=88.2%).

Power generated by the generator unit=51,059 kw×88.2%=45,034 kw power produced by a single nozzle.

45,034 kw×4 nozzles=180,136 KW=180 MW . . . generated power of the overall unit including four nozzles.

Therefore, the net out put will be 180,136 KW to be deducted the total consumption of all pump (51,052 KW)=129 MW . . . therotical result.

6. Sophisticate micro adjustment

After turning the pressure pump control switch to 180 MW indication mark, continue to make “micro adjustment” according to “generated output power ” until reaching the value “180000000 w. At the same time turn the tail water pump switch to the same graduation as that indication by the pressure pump switch so as to maintain the quantity of pumped tail water can cope with the pressure produced by the pressure pump (the reason why is that when the pressure pump operate with a high rotational speed to pump up a large quantity of water, the tail water pump has to pump up comparative quantity of the tail water to keep pace with the action of the former.). When the generated power output is indicated at the graduation “180,000,000 W”, stop micro adjustment of two kinds of pumps at this position and go into a long time duration work until the time comes when the generated power should be varied or operation be stopped. The time counter will start to count duration of the generator operating time.

(III) Variation of Generator Operation:

When the generator operation is varied from its normal operation state, no matter the generating power increases or decreases, the operation procedures are as follows:

1. Turn both power source switches of pressure pump and tail water pump to the graduation indicating the varied quantity of generation.

2. Immediately make a necessary sophisticate micro adjustment according to the generated power output value indicated on the instrument board.

3. After performing sophisticate micro adjustment, return the time counter to its initial zero position. The above normal operation is carried out with 180MW quantity of generation as example, calculation of water flow and energy has been illustrated as above. As for the calculation of the minor water flow and energy will not be done herein.

4. Stop operation

Turn the power source switches of both kinds of pumps to “warming up” position so as to slowly operate for 10 min., then return the switches to their “zero” positions so as to completely cease the pumping and generating operation, and record the duration of the generator running time.

While the invention has been described in terms of what are presently considered to be the most practical and preferred embodiment, it is to be understood that the invention need not be limited to the disclosed embodiment. On the contrary, it is intended to cover various modifications and similar arrangement included within the spirit and scope of the appended claims which are to be accorded with the broadest interpretation so as to encompass all such modifications and similar structures.

### INDUSTRIAL APPLICABILITY

The present system utilizes a small numbers of pumps to incessantly pump up the tail water to form a circulatory water flow, and convert the water flow in the conduits into a high jet flow with the taper conduits according to equation of flow mechanics, and again use the high jet flow to drive the group of Pelton turbine generators. In this way, a large scale commercially applicable power generation system can be established with minor quantity of pump power. The present system can be installed anywhere without limitation. By only filling up once a required quantity of water, the circulatory water flow can be maintained for power generation for a long time so as to achieve the maximum utilization effect.

What is claimed is:

1. A power generator system utilizing the jet power of circulatory water flow in the taper conduits comprising:
a jet component which further including a group of conduit, wherein said conduit is combined by a front big diameter conduit, a middle 30° taper conduit, and a rear small diameter nozzle; a horizontal axial flow pump is provided in the front big diameter conduit, and supplies enough power to the water flow in said conduit when it runs to overcome the resistance of said middle 30° taper conduit, said taper conduit can increase the velocity of water flow in said front big diameter conduit to form high speed jet flow of said rear small diameter nozzle according to continuity equation of flow mechanics;
a set Pelton turbine generators driven to generate electricity by utilizing said jet flow; and
a pumping-up tail water circulation device to pump up the tail water from the sealed tail water pond the ground, to incessantly and circularly supply the water needed by said taper conduit.

2. The power generation system of claim 1, wherein said pumping up tail water circulation device includes a sealed underground tail water pond in water turbine chamber in which said tail water is unable to flow out, the fall down tail water flows down along the tail water conduit connected with said tail water pond to the level lower than the jet component, and exact quantity of tail water is pumped up incessantly with a tail pump to the ground so as to circulate incessantly and supply water for said jet component to form a jet flow.
